(19) United States
(12) Patent Application Publication
(10) Pub. No.: US 2007/0103897 A1
(43) Pub. Date: May 10, 2007

(54) Lamp string device

(76) Inventor: Chong Ying Lu, Miao-Li Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/270,559

(22) Filed: Nov. 10, 2005

(51) Int. Cl. F21L 4/00

(52) U.S. Cl. 362/183; 362/252

(57) ABSTRACT

A lamp string device comprises a solar panel connected to an energy storage device. The solar panel absorbs solar energy and converts it to electric energy transmitted to the energy storage device. The energy storage device is also connected to a voltage converter capable of converting the voltage of the energy storage device to one suitable for a lamp string. The lamp string device can store electric energy converted from solar energy in the daytime and use the stored electric energy to light the lamp string at night, thus accomplishing the object of energy saving.

### BACKGROUND OF THE INVENTION

1. Field of the Invention

The present invention relates to a lamp string device and, more particularly, to a lamp string device capable of saving energy and of convenient installation.

2. Description of Related Art

Decorative lamp strings are frequently used in various festivities. They can transform dull and dark night sky into a glorious and flourishing atmosphere. Especially, many Christmas lamp strings are arranged on trees in the street at Christmas to welcome the advent of Christmas. Taiwan is one of the countries that export most Christmas lamp strings to the United State. Because the market is large, the competition is very intense. Manufacturers of Taiwan constantly propose new products, from new Christmas lamp string structures to circuits for controlling the operation of lamp string. For instance, Taiwan Pat. No. 534,274 disclosed an improved Christmas lamp string structure, and Taiwan Pat. No. 531,114 disclosed a remote control device of lamp string control box.

When a conventional lamp string device is to be installed, the whole roll of lamp string is first wound around a tree, and a control box is then connected to an end point of the lamp string. This control box can control the light emitting action of light bulbs on the lamp string. This control box is a remote control one of a manual control one. One end of the control box is connected to the power to light the whole lamp string. Usually, the lamp string is installed only at specific festivals, the total up time of lamp string is about within 1000 hours, and the installation spot won't be fixed at the same location. Therefore, a fixed power cannot be certainly provided at the spot for installing the lamp string. It is usually necessary to use an extension power cord to extend the power to the installation spot. Therefore, the power connection is a big problem for the installation of lamp string. Besides, because the lamp string is turned on for about 8 to 10 hours each day, the consumed electricity is another big problem in nowadays when countries all over the world promote activities for energy saving.

Accordingly, the present invention proposes a lamp string device to effectively solve the above problems in the prior art.

### SUMMARY OF THE INVENTION

An object of the present invention is to provide a lamp string device, which uses electric energy converted from solar energy and stored at daytime to light a lamp string at night so as to save energy.

Another object of the present invention is to provide a lamp string device, which uses electric energy converted from solar energy to replace the power source of a conventional lamp string. Therefore, it is not necessary to take the power source into account when installing a lamp string. In other words, one needs not to consider whether there is a power source near the spot for installing the lamp string. Therefore, there is little restriction on the location for installing a lamp string, and the installation is more convenient.

To achieve the above objects, the present invention provides a lamp string device, which comprises a solar panel, an energy storage device, and a voltage converter. The solar panel is connected to the energy storage device. The solar panel is used to absorb and convert solar energy to electric energy that is sent to the energy storage device. The energy storage device provides electric energy transmitted from the solar panel. The energy storage device is connected to the voltage converter. The voltage converter can convert the voltage of the energy storage device to another voltage that is output to at least a lamp string to light the lamp string

### BRIEF DESCRIPTION OF THE DRAWINGS

The various objects and advantages of the present invention will be more readily understood from the following detailed description when read in conjunction with the appended drawing, in which:

FIG. 1 is a block diagram according to a first embodiment of the present invention;

FIG. 2 is a block diagram according to a second embodiment of the present invention; and

FIG. 3 is a block diagram according to a third embodiment of the present invention.

### DETAILED DESCRIPTION OF THE PREFERRED EMBODIMENTS

The present invention provides a lamp string device that is suitably installed outdoors, e.g., decoration lamps installed on trees in the street. The present invention differs from the prior art in that it is not necessary to provide an extra power source to light the lamp string. At daytime, the solar energy is converted to electric energy that is stored for lighting the lamp string at night.

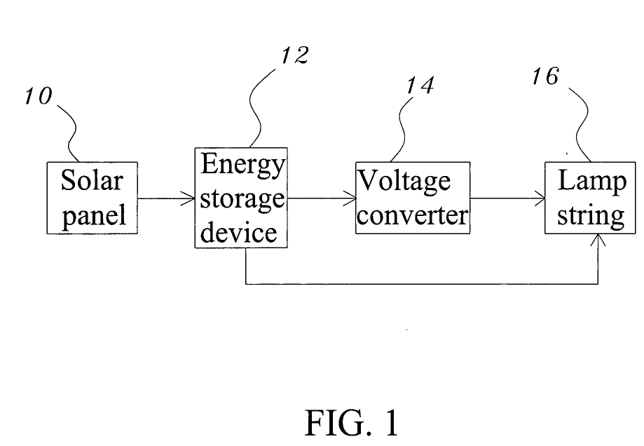

As shown in FIG. 1, a lamp string device of the present invention comprises a solar panel 10, an energy storage device 12, and a voltage converter 14. The solar panel 10 can convert 12% to 14% of solar energy to electric energy. The solar panel 10 is primary a silicon crystal composed of p-type semiconductor containing boron and n-type semiconductor containing phosphorous. When illuminated by light, electrons and holes will be generated to form an anode and a cathode and build a voltage. Through this way, the optical energy can be converted to electric energy. The solar panel 10 is connected to the energy storage device 12. The energy storage device 12 is a rechargeable battery, which can be selected among nickel hydride battery, nickel cadmium battery, and lithium battery. When the solar panel 10 converts solar energy to electric energy, the electric energy can be stored in the energy storage device 12.

The energy storage device is connected to the voltage converter 14. The voltage converter 14 is a boost converter capable of converting a lower voltage to a higher one for output. The voltage converter 14 can convert the voltage of the energy storage device to another voltage that is output to a lamp string 16 to light the lamp string 16. A plurality of LEDs is disposed on the lamp string 16. The LEDs are of electroluminescent type.

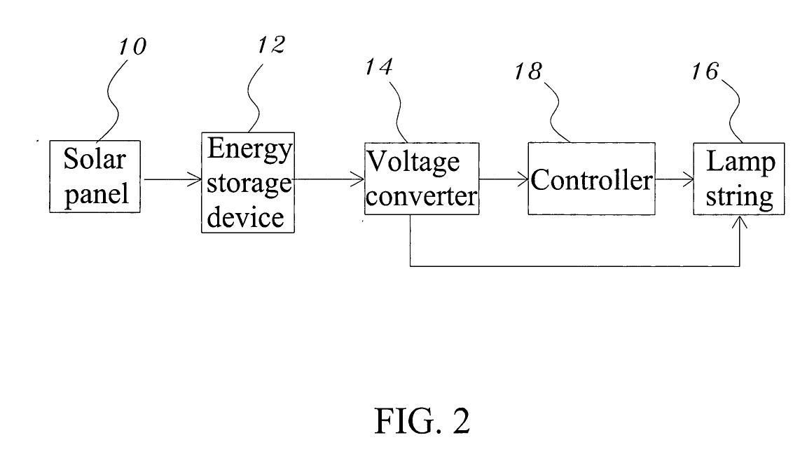

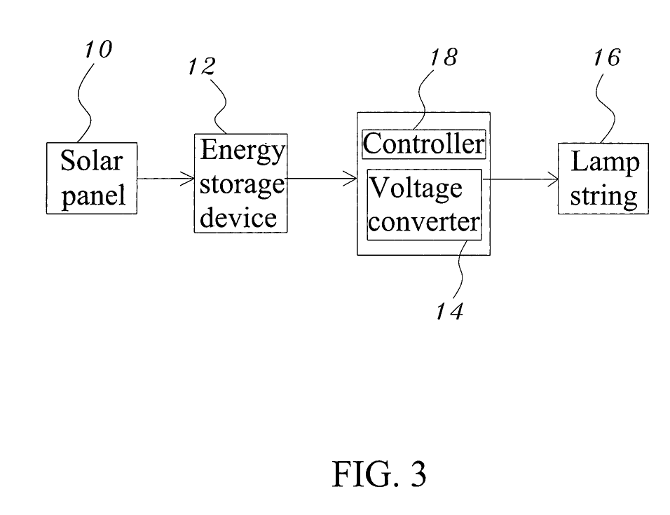

FIG. 2 is a block diagram according to a second embodiment of the present invention. A controller 18 is disposed between the voltage converter 14 and the lamp string 16. The controller 18 is used to control the light emitting patterns (e.g., the frequency, time (on and off) and order) of the LEDs on the lamp string 16. The voltage converter 14 and the controller 18 can also be integrated in a single IC chip to save the occupied space, as shown in FIG. 3.

To sum up, the present invention uses electric energy converted from solar energy by the solar panel 10 and stored at daytime to light the lamp string 16 at night so as to save energy. Because the present invention uses electric energy converted from solar energy to replace the power source of a conventional lamp string, it is not necessary to take the power source into account when installing a lamp string. In other words, one needs not to consider whether there is a power source near the spot for installing the lamp string. Therefore, there is little restriction on the location for installing a lamp string, and the installation is more convenient.

Although the present invention has been described with reference to the 5 preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A lamp string device comprising:
a solar panel for absorbing and converting solar energy to electric energy;
an energy storage device connected to said solar panel and used for storing electric energy transmitted from said solar panel; and
a voltage converter connected to said energy storage device and used to convert a voltage of said energy storage device to another voltage that is output to at least a lamp string to light said lamp string.

2. The lamp string device as claimed in claim 1, wherein a plurality of LEDs is disposed on said lamp string.

3. The lamp string device as claimed in claim 1, wherein said LEDs are of electroluminescent type.

4. The lamp string device as claimed in claim 1, wherein said energy storage device is a rechargeable battery.

5. The lamp string device as claimed in claim 1, wherein said energy storage device is selected among nickel hydride battery, nickel cadmium battery, and lithium battery.

6. The lamp string device as claimed in claim 1, wherein said lamp string device is used as a decoration lamp.

7. The lamp string device as claimed in claim 1 further comprising a controller, wherein said controller is disposed between said voltage converter and said lamp string.

8. The lamp string device as claimed in claim 7, wherein said voltage converter can be built in said controller.

9. The lamp string device as claimed in claim 1, wherein said voltage converter is a boost converter.
